(19) United States
(12) Patent Application Publication
(10) Pub. No.: US 2023/0325248 A1
(43) Pub. Date: Oct. 12, 2023

(54) COMPUTER SYSTEM AND DATA CONSISTENCY MAINTENANCE METHOD

(71) Applicant: Hitachi, Ltd., Tokyo (JP)

(72) Inventors: Jumpei OKOSHI, Tokyo (JP); Masayuki SAKATA, Tokyo (JP); Shotaro NODA, Tokyo (JP)

(21) Appl. No.: 18/120,577

(22) Filed: Mar. 13, 2023

(30) Foreign Application Priority Data
Apr. 12, 2022 (JP) 2022-065633

(51) Int. Cl. G06F 9/50

(52) U.S. Cl. CPC G06F 9/5038; G06F 2209/5017

(57) ABSTRACT

A data inconsistency correction method to be applied is selected in consideration of a specification of a transaction, execution status of the transaction, and the like. A computer system includes a computer that executes a service, is connected to a computer that divides a transaction across a plurality of services into a plurality of local transactions and executes the plurality of local transactions, and holds service management information for managing a specification of the local transaction in the service and program management information for storing a program for correcting data inconsistency and data associated with an application condition. The computer system selects the program to be applied based on the service management information, the program management information, and execution states of the plurality of local transactions when a failure of the transaction is detected.

### CLAIM OF PRIORITY

The present application claims priority from Japanese patent application JP 2022-065633 filed on Apr. 12, 2022, the content of which is hereby incorporated by reference into this application.

### TECHNICAL FIELD

The present invention relates to a technique for correcting data inconsistency in a distributed transaction.

### BACKGROUND ART

Use of a micro service that implements one function by combining a plurality of services is active. Meanwhile, it is known that it is difficult to maintain data consistency in a distributed transaction in the micro service. In response to this, a method for maintaining data consistency by using a saga pattern is known.

In the saga pattern, the transaction in the micro service is divided into a plurality of local transactions, and individual local transactions are executed. A series of local transactions are called a saga. In the saga pattern, a compensation transaction is executed as a rollback method associated with a failure of the local transaction. Accordingly, the data consistency in the distributed transaction can be maintained.

However, even when the saga pattern is used, maintenance of data consistency associated with a failure of saga itself is a problem. Therefore, it is necessary to perform reconciliation processing to confirm the data consistency and to maintain the data consistency. In response to this, a technique described in PTL 1 is known.

PTL 1 discloses that “A system and a method for supporting a transaction recovery based on inline delegation of a transaction log to a database are provided. The system can acquire transaction recovery information of a certain transaction from a persistent storage device. During a preparation phase, the transaction recovery information is continued in a resource manager associated with the persistent storage device. Further, the system can acquire one or more in-doubt transactions from one or more participating resource managers of the transaction. Next, the system can determine whether to commit or rollback the above one or more in-doubt transactions by butting the above one or more in-doubt transactions with the above transaction recovery information.”

### CITATION LIST

### Patent Literature

PTL 1: JP2015-514247T

### SUMMARY OF INVENTION

### Technical Problem

In PTL 1, commit or rollback of a failed transaction can be performed based on the transaction log and the recovery information.

However, since there are a plurality of data inconsistency correction methods, it is necessary to select a correction method according to a specification of a transaction in a service, execution status of the transaction, and the like.

An object of the invention is to provide a technique for selecting a data inconsistency correction method to be applied in consideration of a specification of a transaction, execution status of the transaction, and the like.

### Solution to Problem

A representative example of the invention disclosed in the present application is as follows. That is, a computer system includes at least one computer including a processor, a storage device connected to the processor, and a network interface connected to the processor. The computer system is connected to at least one first computer that is configured to execute a service and at least one second computer that is configured to divide a transaction across a plurality of services into a plurality of local transactions and execute the plurality of local transactions. The computer system is configured to hold service management information for managing a specification of the local transaction in the service and program management information for storing a program executed to correct data inconsistency caused by a failure of the transaction and data associated with an application condition. The at least one computer is configured to confirm execution states of the plurality of local transactions when the failure of the transaction is detected, select the program to be applied based on the service management information, the program management information, and the execution states of the plurality of local transactions, and execute data consistency maintenance processing implemented by the selected program.

### Advantageous Effects of Invention

According to the invention, a management computer determines, based on an attribute of a session, a migration order of a plurality of pieces of session information such that an interruption time of communication using the session is short and an effect of the migration of the session information is rapidly reflected in a communication system. By migrating the plurality of pieces of session information according to the determined migration order, an interruption time of a communication service can be shortened, and time for reflecting an effect of scale-out can be shortened. Problems, configurations, and effects other than those described above will be apparent from the following description of embodiments.

### BRIEF DESCRIPTION OF DRAWINGS

FIG. 1 is a diagram illustrating a configuration example of a system according to a first embodiment.

FIG. 2 is a diagram illustrating a hardware configuration of a data consistency maintenance apparatus according to the first embodiment.

FIG. 3A is a diagram illustrating an example of distributed transaction related information according to the first embodiment.

FIG. 3B is a diagram illustrating an example of the distributed transaction related information according to the first embodiment.

FIG. 4 is a diagram illustrating an example of program management information according to the first embodiment.

FIG. 5A is a diagram illustrating an example of a program according to the first embodiment.

FIG. 5B is a diagram illustrating an example of the program according to the first embodiment.

FIG. 6 is a diagram illustrating an example of a screen displayed by the data consistency maintenance apparatus according to the first embodiment.

FIG. 7 is a diagram illustrating an example of the screen displayed by the data consistency maintenance apparatus according to the first embodiment.

FIG. 8 is a sequence diagram illustrating an execution flow of a distributed transaction in the system according to the first embodiment.

FIG. 9 is a flowchart illustrating an example of data consistency maintenance program determination processing executed by the data consistency maintenance apparatus according to the first embodiment.

FIG. 10A is a diagram illustrating an example of an execution flow of a local transaction according to the first embodiment.

FIG. 10B is a diagram illustrating an example of the execution flow of the local transaction according to the first embodiment.

FIG. 11A is a diagram illustrating an example of an update state of local transaction execution state management information according to the first embodiment.

FIG. 11B is a diagram illustrating an example of the update state of the local transaction execution state management information according to the first embodiment.

FIG. 11C is a diagram illustrating an example of the update state of the local transaction execution state management information according to the first embodiment.

### DESCRIPTION OF EMBODIMENTS

An embodiment of the invention will be described below with reference to the drawings. However, the invention should not be construed as being limited to the description of the embodiment described below. A person skilled in the art will easily understand that specific configurations can be changed without departing from a spirit or a scope of the invention.

In configurations of the invention described below, the same or similar configurations or functions are denoted by the same reference numerals, and a repeated description thereof is omitted.

In the present specification, expressions such as “first”, “second”, and “third” are used to identify components, and do not necessarily limit the number or order.

The positions, sizes, shapes, ranges, and the like of the respective components illustrated in the drawings may not represent actual positions, sizes, shapes, ranges, and the like in order to facilitate understanding of the invention. Therefore, the invention is not limited to the positions, the sizes, the shapes, the ranges, and the like disclosed in the drawings.

### First Embodiment

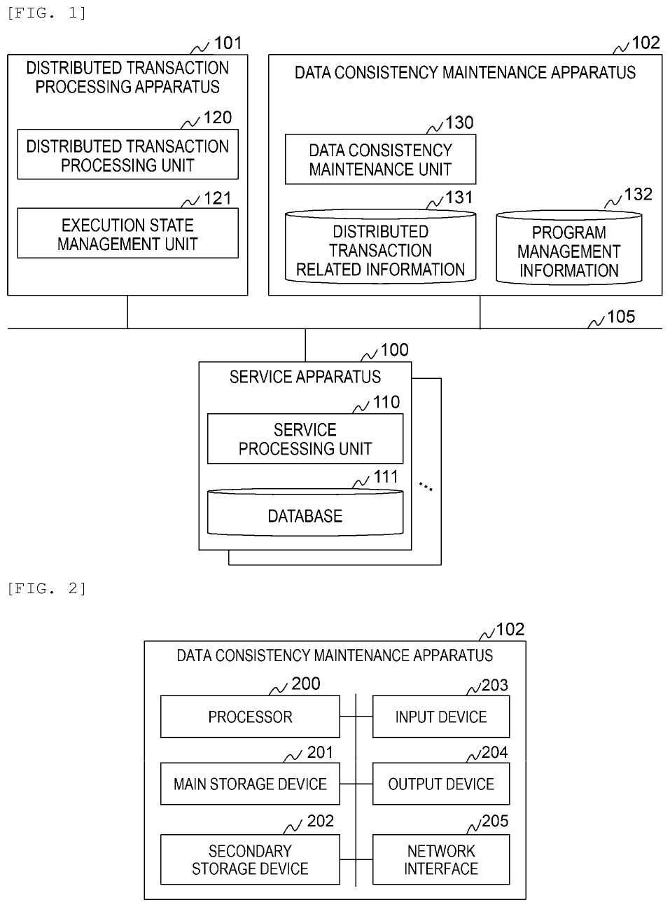

FIG. 1 is a diagram illustrating a configuration example of a system according to a first embodiment.

The system includes a service apparatus 100, a distributed transaction processing apparatus 101, and a data consistency maintenance apparatus 102. The apparatuses are connected to each other via a network 105. The network 105 is, for example, a local area network (LAN) or a wide area network (WAN). A connection method of the network 105 may be wired or wireless.

The service apparatus 100 is an apparatus that executes a service constituting a micro service. The service apparatus 100 includes a service processing unit 110 and a database 111. The service processing unit 110 executes a service. The database 111 stores information related to the service executed by the service apparatus 100.

The distributed transaction processing apparatus 101 is an apparatus that controls execution of a transaction (distributed transaction) across a plurality of services. The distributed transaction processing apparatus 101 includes a distributed transaction processing unit 120 and an execution state management unit 121. The distributed transaction processing unit 120 controls a distributed transaction. The execution state management unit 121 manages an execution state of a local transaction obtained by dividing the distributed transaction.

The data consistency maintenance apparatus 102 is an apparatus that maintains data consistency in the distributed transaction. The data consistency maintenance apparatus 102 includes a data consistency maintenance unit 130, distributed transaction related information 131, and program management information 132. The data consistency maintenance unit 130 monitors the data inconsistency associated with a failure of the distributed transaction, and when the data inconsistency is detected, selects a program to be executed to correct data inconsistency (data consistency maintenance program), and executes the program. The distributed transaction related information 131 is information on the distributed transaction. The program management information 132 is information for managing the data consistency maintenance program.

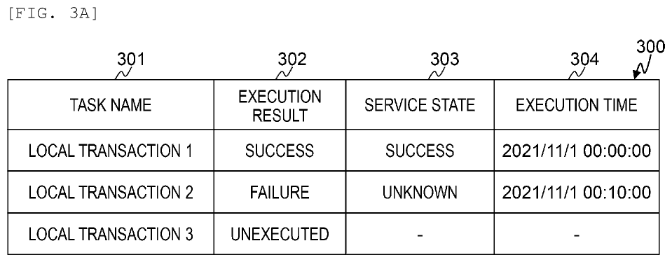

Here, a hardware configuration of each apparatus will be described. FIG. 2 is a diagram illustrating a hardware configuration of the data consistency maintenance apparatus 102 according to the first embodiment. The service apparatus 100 and the distributed transaction processing apparatus 101 have the same hardware configuration.

The data consistency maintenance apparatus 102 includes a processor 200, a main storage device 201, a secondary storage device 202, an input device 203, an output device 204, and a network interface 205.

The processor 200 executes a program stored in the main storage device 201. The processor 200 operates as a functional unit (module) that implements a specific function by executing processing according to the program. In the following description, when the processing is described with the functional unit as a subject, it indicates that the processor 200 executes a program for implementing the functional unit.

The main storage device 201 is a dynamic random access memory (DRAM) or the like, and stores the program executed by the processor 200 and information used by the program. In addition, the main storage device 201 is also used as a work area. The secondary storage device 202 is a hard disk drive (HDD), a solid state drive (SSD) or the like. The program and information stored in the main storage device 201 may be stored in the secondary storage device 202. In this case, the processor 200 reads the program and information from the secondary storage device 202 and loads the program and information into the main storage device 201.

The input device 203 is a keyboard, a mouse, a touch panel, or the like, and the output device 204 is a display or the like. The network interface 205 is an interface for communicating with an external device via a network.

The service apparatus 100, the distributed transaction processing apparatus 101, and the data consistency maintenance apparatus 102 may not include the input device 203 and the output device 204.

The service apparatus 100, the distributed transaction processing apparatus 101, and the data consistency maintenance apparatus 102 may be implemented by using a virtualization technique. In addition, functions of the service apparatus 100, the distributed transaction processing apparatus 101, and the data consistency maintenance apparatus 102 may be implemented by using a plurality of computers.

For functional units of the service apparatus 100, the distributed transaction processing apparatus 101, and the data consistency maintenance apparatus 102, a plurality of modules may be combined into one module, or one module may be divided into a plurality of modules for each of functions.

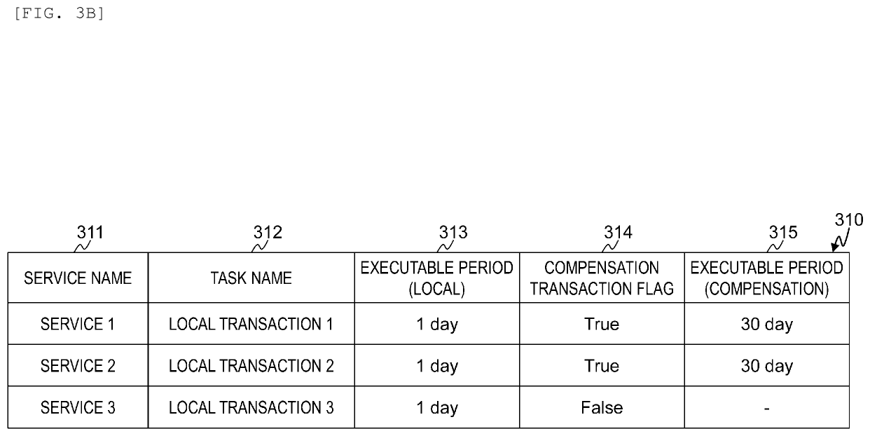

FIGS. 3A and 3B are diagrams illustrating examples of the distributed transaction related information 131 according to the first embodiment.

The distributed transaction related information 131 stores local transaction execution state management information 300 and service management information 310.

The local transaction execution state management information 300 is information for managing the execution state of the local transaction, and stores an entry including a task name 301, an execution result 302, a service state 303, and an execution time 304. One entry exists for one local transaction. The fields included in the entry are not limited to those described above. Any one of the fields described above may not be included, or another field may be included.

The task name 301 is a field that stores a name of the local transaction. The execution result 302 is a field that stores the execution state of the local transaction. The service state 303 is a field that stores a state of a service to be executed by the local transaction. The execution time 304 is a field that stores an execution time of the local transaction.

The service management information 310 is information for managing a specification of a local transaction in a service constituting the micro service, and includes a service name 311, a task name 312, an executable period (local) 313, a compensation transaction flag 314, and an executable period (compensation) 315. One entry exists for a combination of a service and a local transaction. The fields included in the entry are not limited to those described above. Any one of the fields described above may not be included, or another field may be included.

The specification of the local transaction in the service means, for example, an implementation and execution condition of the local transaction.

The service name 311 is a field that stores a name of the service. The task name 312 is a field that stores a name of a local transaction that targets the service. The executable period (local) 313 is a field that stores a period during which the local transaction can be executed after an execution opportunity of the local transaction occurs.

The compensation transaction flag 314 is a field that stores a flag indicating whether a compensation transaction for canceling an operation based on the local transaction is implemented.

When the compensation transaction is implemented, “Ture” is stored, and when the compensation transaction is not executed, “False” is stored. The executable period (compensation) 315 is a field that stores a period during which the compensation transaction can be executed after an execution opportunity of the compensation transaction occurs. The executable period (compensation) 315 of an entry in which the compensation transaction flag 314 is “False” is blank.

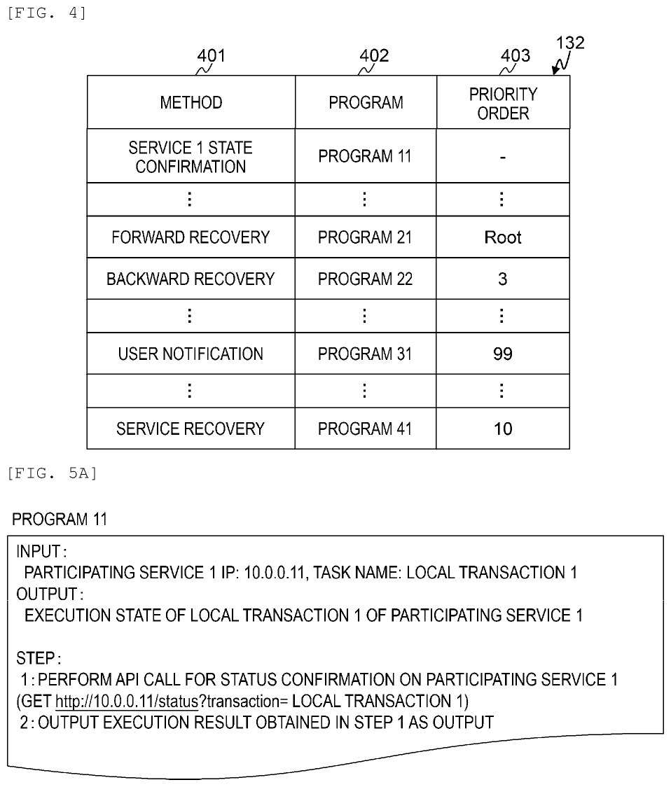

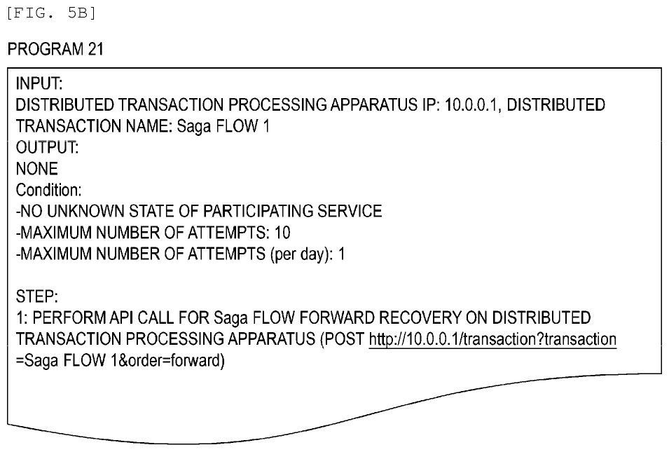

FIG. 4 is a diagram illustrating an example of the program management information 132 according to the first embodiment. FIGS. 5A and 5B are diagrams illustrating examples of the program according to the first embodiment.

The program management information 132 stores an entry including a method 401, a program 402, and a priority order 403. One entry exists for one program. The fields included in the entry are not limited to those described above. Any one of the fields described above may not be included, or another field may be included.

The method 401 is a field for information on a method that is implemented following the program. The program 402 is a field that stores a program for implementing the method 401. In FIG. 4, a name of the program is described for description, and the program 402 stores an execution file of the program, a path in which the execution file is stored, or the like.

The priority order 403 is a field that stores a priority order to which the data consistency maintenance program is applied. Root has a highest priority order. In addition, the smaller the value is, the higher the priority order is.

In the first embodiment, the priority order is set for the data consistency maintenance program, and the priority order is not set for a program (improvement program) for implementing improvement for satisfying an application condition of the data consistency maintenance program.

The program managed by the program management information 132 is, for example, a program that executes processing of contents as illustrated in FIGS. 5A and 5B. FIG. 5A illustrates an example of the improvement program. FIG. 5B illustrates an example of the data consistency maintenance program. The data consistency maintenance program includes the application condition. The application condition may be included in the program management information 132.

Next, processing in the system will be described.

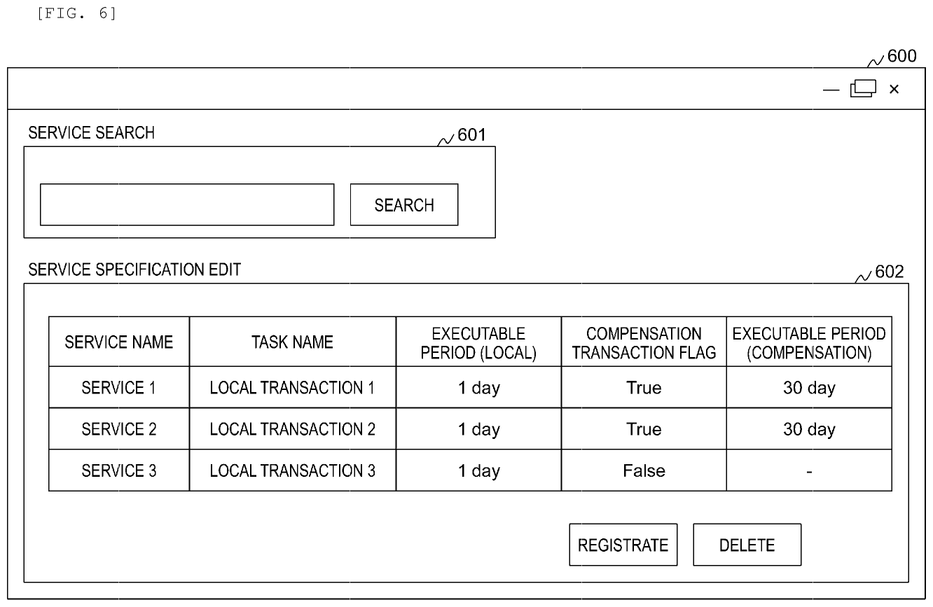

A user who manages or uses the micro service registers information on handling of the local transaction in the service constituting the micro service in the data consistency maintenance apparatus 102. For example, the information is registered by using a screen 600 as illustrated in FIG. 6.

The screen 600 includes a search column 601 and a service specification edit column 602. The search column 601 is a column for searching for a service. When the user inputs a name of a service and presses a search button, the data consistency maintenance unit 130 searches a corresponding entry from the service management information 310, and displays the entry in the service specification edit column 602. The service specification edit column 602 is a column for editing the specification of the local transaction in the service. In the service specification edit column 602, a table having the same data structure as the service management information 310 is displayed. When the user inputs necessary information to the entry and presses a register button, data (entry) related to the specification of the local transaction in the service is registered in the service management information 310. When the user selects an entry and presses a delete button, data (entry) is deleted from the service management information 310.

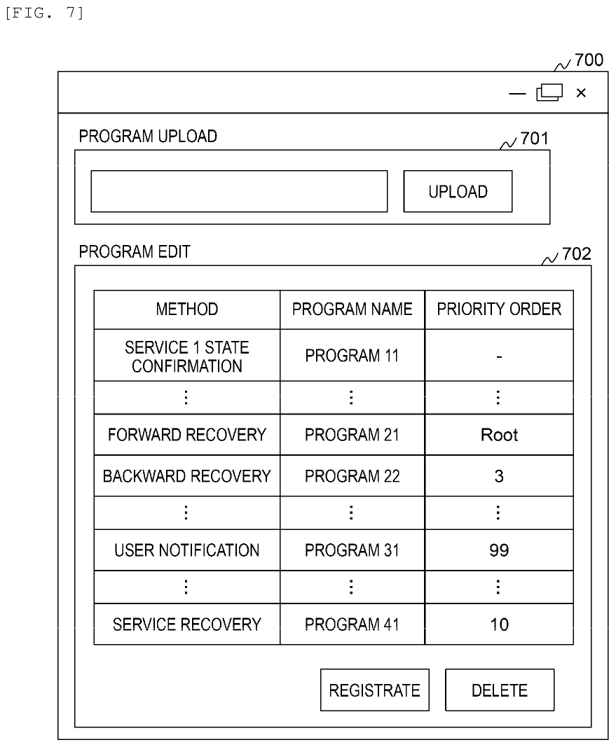

The user who manages or uses the micro service registers the program in the data consistency maintenance apparatus 102. For example, a program is registered by using a screen 700 as illustrated in FIG. 7.

The screen 700 includes an upload column 701 and a program edit column 702. The upload column 701 is a column for uploading a program to the data consistency maintenance apparatus 102. When the user selects a program and presses an upload button, the data consistency maintenance unit 130 registers the program in the program management information 132. The program edit column 702 is a column for editing a method, a priority order, and the like implemented by the program. A table having the same data structure as the program management information 132 is displayed in the program edit column 702. When the user inputs necessary information to the entry and presses the registration button, information is registered in the entry of the program management information 132. When the user selects an entry and presses the delete button, the entry is deleted from the program management information 132.

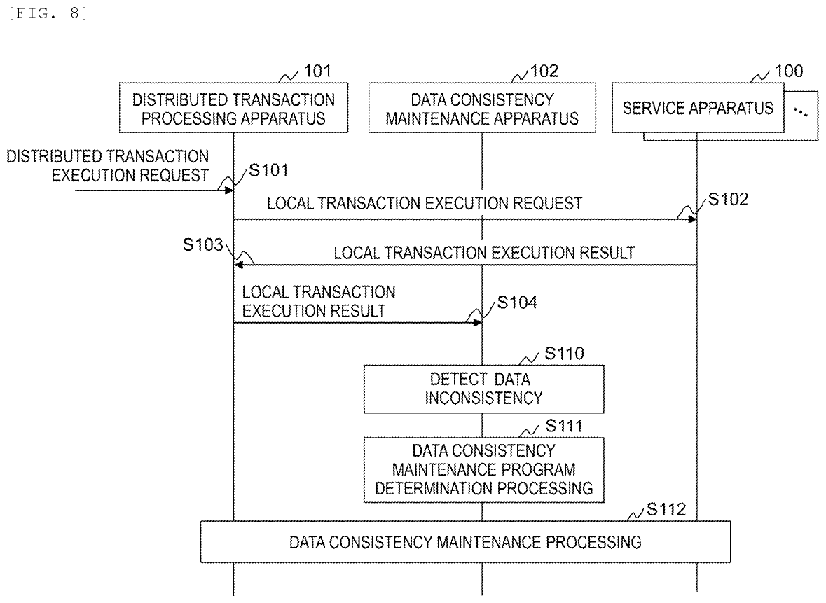

FIG. 8 is a sequence diagram illustrating an execution flow of the distributed transaction in the system according to the first embodiment.

The distributed transaction processing apparatus 101 receives a distributed transaction execution request from the user (step S101).

The distributed transaction processing unit 120 of the distributed transaction processing apparatus 101 transmits a local transaction execution request to the service apparatus 100 according to the execution flow of the local transaction (step S102).

At this time, the execution state management unit 121 transmits information on the execution flow of the local transaction to the data consistency maintenance apparatus 102. The data consistency maintenance apparatus 102 generates the local transaction execution state management information 300 based on the information. “Unexecuted” is stored in the execution result 302 of each entry. In addition, the service state 303 and the execution time 304 of each entry are blank.

When the local transaction execution request is received, the service apparatus 100 performs various operations according to the local transaction, and transmits a local transaction execution result including results of the operations and the like to the distributed transaction processing apparatus 101 (step S103). The service apparatus 100 may include the state of the service in the local transaction execution result, the execution state management unit 121 of the distributed transaction processing apparatus 101 transmits the local transaction execution result to the data consistency maintenance apparatus 102 (step S104).

When data inconsistency associated with a stop of the execution flow of the local transaction is detected (step S110), the data consistency maintenance apparatus 102 executes the data consistency maintenance program determination processing (step S111). Details of the data consistency maintenance program determination processing will be described later.

For example, when the execution results 302 of all the entries are not “success” within a certain period after the local transaction execution state management information 300 is generated, or when a notification of a failure of the execution flow of the local transaction is received from the distributed transaction processing apparatus 101, the data consistency maintenance apparatus 102 can detect the stop of the execution flow of the local transaction.

The data consistency maintenance apparatus 102 executes data consistency maintenance processing according to the data consistency maintenance program determined by the data consistency maintenance program determination processing (step S112).

For example, re-execution of the local transaction, the execution of the compensation transaction, or rollback of the database by the service apparatus 100 is executed.

When the data inconsistency is detected after the data consistency maintenance processing is executed (step S110), the data consistency maintenance apparatus 102 executes the same processing (steps S111 and S112).

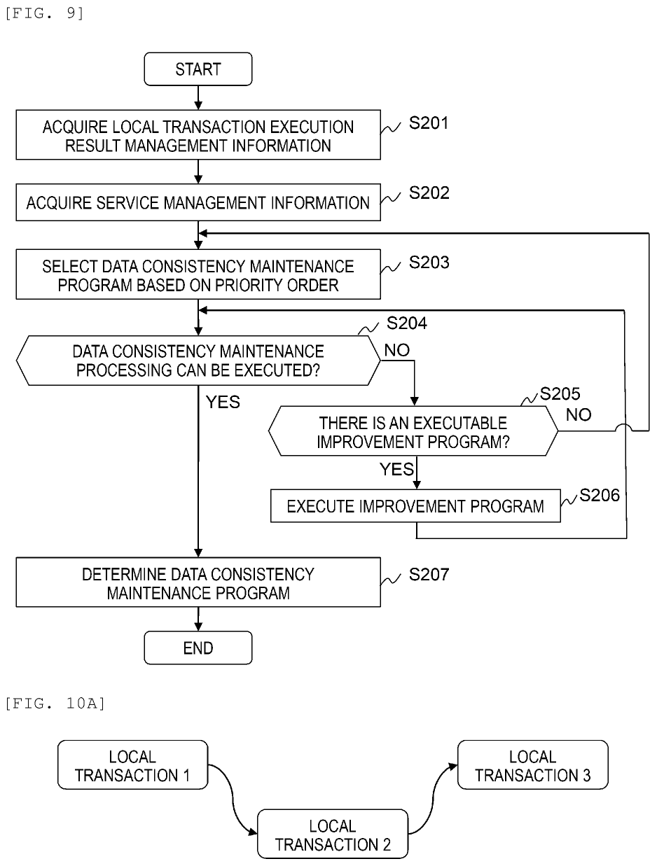

FIG. 9 is a flowchart illustrating an example of the data consistency maintenance program determination processing executed by the data consistency maintenance apparatus 102 according to the first embodiment.

The data consistency maintenance unit 130 acquires the local transaction execution state management information 300 and the service management information 310 (steps S201 and S202).

The data consistency maintenance unit 130 refers to the program management information 132 and selects the data consistency maintenance program based on the priority order (step S203). The data consistency maintenance program is selected in order from the Root.

The data consistency maintenance unit 130 determines whether the data consistency maintenance processing based on the selected data consistency maintenance program can be executed based on the application condition of the selected data consistency maintenance program and the service management information 310 (step S204).

Specifically, the data consistency maintenance unit 130 refers to the service management information 310 to specify a local transaction in which a trouble occurred. That is, an entry in which the execution result 302 is “failure” is searched. The data consistency maintenance unit 130 refers to an entry corresponding to the specified local transaction in the service management information 310 and the application condition of the selected data consistency maintenance program to determine whether the data consistency maintenance processing based on the selected data consistency maintenance program can be executed.

For example, when the selected data consistency maintenance program is a program for executing the re-execution of the local transaction, the following determination is performed. The data consistency maintenance unit 130 refers to the executable period (local) 313 and determines whether a current time is within an executable period of the local transaction. When the current time is within the executable period of the local transaction, the data consistency maintenance unit 130 determines whether the application condition of the selected data consistency maintenance program is satisfied. At this time, the data consistency maintenance unit 130 may refer to the entry of the service management information 310.

When it is determined that the data consistency maintenance processing based on the selected data consistency maintenance program cannot be executed, the data consistency maintenance unit 130 determines whether there is an executable improvement program (step S205).

Specifically, when the data consistency maintenance processing based on the selected data consistency maintenance program cannot be executed due to the fact that the application condition is not satisfied, the data consistency maintenance unit 130 refers to the program management information 132 based on a determination result in step S204, and determines whether there is an improvement program that can be executed to improve the application condition in the method 401.

When it is determined that there is an executable improvement program, the data consistency maintenance unit 130 executes the improvement program (step S206), and then returns to step S204. Possibility of execution of the data consistency maintenance program can be improved by executing the improvement program. Accordingly, a data consistency maintenance program to be preferentially applied can be executed.

When it is determined that there is no executable improvement program, the data consistency maintenance unit 130 returns to step S203 and selects a new data consistency maintenance program.

When it is determined in step S204 that the data consistency maintenance processing based on the selected data consistency maintenance program can be executed, the data consistency maintenance unit 130 determines execution of the data consistency maintenance program (step S207).

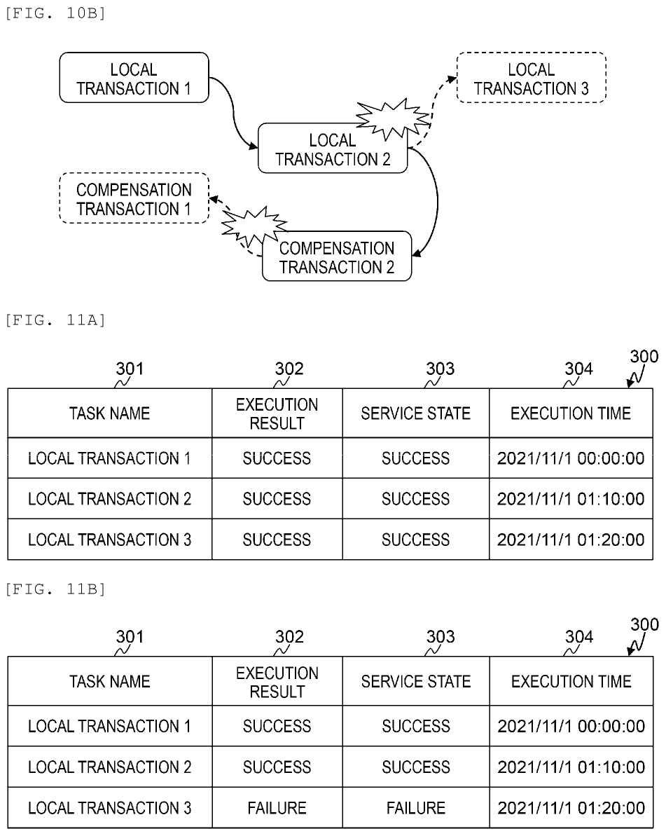

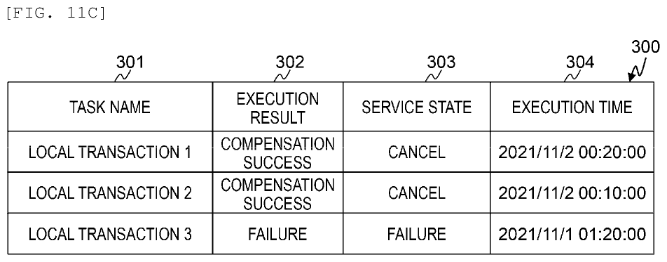

Here, the processing executed by the data consistency maintenance apparatus 102 will be described using a specific example. FIGS. 10A and 10B are diagrams illustrating examples of the execution flow of the local transaction according to the first embodiment. FIGS. 11A, 11B, and 11C are diagrams illustrating examples of an update state of the local transaction execution state management information 300 according to the first embodiment.

As illustrated in FIG. 10A, an execution flow of the local transaction in which a local transaction 1, a local transaction 2, and a local transaction 3 are sequentially executed is assumed. At this time, it is assumed that the service management information 310 is in the state illustrated in FIG. 3B.

When the local transaction 2 fails, the distributed transaction processing apparatus 101 executes a compensation transaction 2 and a compensation transaction 1 in order to maintain data consistency. However, when the compensation transaction 2 fails, the execution flow is stopped in a state in which only the local transaction 1 is executed. Therefore, the data inconsistency occurs.

The local transaction execution state management information 300 in FIG. 10B is assumed to be in the state illustrated in FIG. 3A. In addition, it is assumed that the execution time of the data consistency maintenance program determination processing is “2021/11/1 01:00:00”.

In step S203, the data consistency maintenance unit 130 selects a program 21 that implements forward recovery.

In step S204, the data consistency maintenance unit 130 determines whether the local transaction 2 based on the program 21 is possible.

Specifically, the data consistency maintenance unit 130 refers to the executable period (local) 313 and determines whether a current time is within an executable period of the local transaction. Here, it is determined that the current time is within the executable period of the local transaction. Further, the data consistency maintenance unit 130 determines whether an application condition of the program 21 is satisfied. A condition indicating the application condition of FIG. 5B is provided as a condition that the state of the service is not unknown. On the other hand, a state of a service 2 is unknown. Therefore, the application condition is not satisfied.

Therefore, the data consistency maintenance unit 130 proceeds to step S205. Here, it is assumed that there is an improvement program for checking the state of the service 2. In step S206, the data consistency maintenance unit 130 executes the improvement program for checking the state of the service 2. As a result, it is assumed that the local transaction execution state management information 300 is updated as illustrated in FIG. 11A.

In step S204, the data consistency maintenance unit 130 determines that the application condition of the program 21 is satisfied. Therefore, the data consistency maintenance unit 130 executes re-execution of the local transaction 2 based on the program 21 as the data consistency maintenance processing.

When the distributed transaction succeeds as a result of the execution of the data consistency maintenance processing, the local transaction execution state management information 300 is in the state as illustrated in FIG. 11B.

When the data consistency maintenance processing is executed but the local transaction 3 fails and the execution flow is stopped again, the data consistency maintenance unit 130 executes the data consistency maintenance program determination processing again. Here, it is assumed that the data consistency maintenance program for executing the compensation transaction is selected since the executable period of the local transaction elapsed. When the execution of the compensation transaction is successful, the local transaction execution state management information 300 is in the state as illustrated in FIG. 11C.

According to the first embodiment, a data inconsistency correction unit to be dynamically applied can be selected in consideration of the specification of the transaction, execution status of the transaction, and the like. Accordingly, the data inconsistency can be automatically corrected in accordance with trouble status, the specification of the transaction, and the like.

The present invention is not limited to the embodiment described above, and includes various modifications. For example, the embodiment described above has been described in detail for easy understanding of the invention, and the invention is not necessarily limited to those including all the configurations described above. A part of the configuration of the embodiment may be added, deleted, and replaced with another configuration.

A part or all of the configurations, functions, processing units, processing methods, or the like described above may be implemented by hardware such as through design using an integrated circuit. In addition, the invention can also be implemented by a program code of software that implements functions of the embodiment. In this case, a storage medium recording the program code is provided to a computer, and a processor in the computer reads out the program code stored in the storage medium. In this case, the program code itself read from the storage medium implements the functions of the above-described embodiment, and the program code itself and the storage medium storing the program code constitute the invention. As a storage medium for supplying such a program code, for example, a flexible disk, a CD-ROM, a DVD-ROM, a hard disk, a solid state drive (SSD), an optical disk, a magneto-optical disk, a CD-R, a magnetic tape, a nonvolatile memory card, or a ROM is used.

The program code for implementing the functions described in the present embodiment can be implemented in a wide range of programs or script languages such as assembler, C/C++, perl, Shell, PHP, Python, and Java (registered trademark).

Further, the program code of the software that implements the functions of the embodiment may be stored in a storage device such as a hard disk or a memory of a computer or a storage medium such as a CD-RW or a CD-R by delivering via a network, and a processor in the computer may read out and execute the program code stored in the storage device or the storage medium.

In the above embodiment, control lines and information lines are considered to be necessary for description, and all control lines and information lines are not necessarily illustrated in the product. All the configurations may be connected to each other.

### REFERENCE SIGNS LIST

100 service apparatus
101 distributed transaction processing apparatus
102 data consistency maintenance apparatus
105 network
110 service processing unit
111 database
120 distributed transaction processing unit
121 execution state management unit
130 data consistency maintenance unit
131 distributed transaction related information
132 program management information
200 processor
201 main storage device
202 secondary storage device
203 input device
204 output device
205 network interface
300 local transaction execution state management information
310 service management information
600, 700 screen

1. A computer system comprising:
at least one computer including a processor, a storage device connected to the processor, and a network interface connected to the processor, wherein
the computer system is connected to at least one first computer that is configured to execute a service and at least one second computer that is configured to divide a transaction across a plurality of services into a plurality of local transactions and execute the plurality of local transactions,
the computer system is configured to hold service management information for managing a specification of the local transaction in the service and program management information for storing a program executed to correct data inconsistency caused by a failure of the transaction and data associated with an application condition, and
the at least one computer is configured to
confirm execution states of the plurality of local transactions when the failure of the transaction is detected,
select the program to be applied based on the service management information, the program management information, and the execution states of the plurality of local transactions, and
execute data consistency maintenance processing implemented by the selected program.

2. The computer system according to claim 1, wherein
the data stored in the program management information includes a priority order,
the at least one computer is configured to
select the data according to the priority order, and
determine, based on the service management information, the application condition included in the selected data, and the execution states of the plurality of local transactions, whether the data consistency maintenance processing implemented by the program corresponding to the selected data can be executed.

3. The computer system according to claim 2, wherein
the at least one computer is configured to
execute improvement processing for implementing improvement for satisfying the application condition when it is determined that the data consistency maintenance processing implemented by the program corresponding to the selected data cannot be applied since the application condition is not satisfied, and
determine whether the data consistency maintenance processing implemented by the program corresponding to the selected data can be executed after the improvement processing is executed.

4. The computer system according to claim 2, wherein
the at least one computer is configured to provide an interface for setting the program, the application condition, and the priority order.

5. The computer system according to claim 1, wherein
the at least one computer is configured to newly select a program and execute data consistency maintenance processing implemented by the newly selected program when the failure of the transaction is detected after the data consistency maintenance processing implemented by the program corresponding to the selected data is executed.

6. The computer system according to claim 1, wherein
the at least one computer is configured to provide an interface for setting the specification of the local transaction in the service.

7. A data consistency maintenance method executed by a computer system, wherein
the computer system includes at least one computer including a processor, a storage device connected to the processor, and a network interface connected to the processor,
the computer system is connected to at least one first computer that is configured to execute a service and at least one second computer that is configured to divide a transaction across a plurality of services into a plurality of local transactions and execute the plurality of local transactions,
the computer system is configured to hold service management information for managing a specification of the local transaction in the service and program management information for storing a program executed to correct data inconsistency caused by a failure of the transaction and data associated with an application condition, and
the data consistency maintenance method comprises:
a first step of confirming execution states of the plurality of local transactions when the failure of the transaction is detected, by the at least one computer;
a second step of selecting the program to be applied based on the service management information, the program management information, and the execution states of the plurality of local transactions, by the at least one computer; and
a third step of executing data consistency maintenance processing implemented by the selected program, by the at least one computer.

8. The data consistency maintenance method according to claim 7, wherein
the data stored in the program management information includes a priority order, and
the second step includes:
a fourth step of selecting the data according to the priority order, by the at least one computer, and
a fifth step of determining, based on the service management information, the application condition included in the selected data, and the execution states of the plurality of local transactions, whether the data consistency maintenance processing implemented by the program corresponding to the selected data can be executed, by the at least one computer.

9. The data consistency maintenance method according to claim 8, wherein
the fifth step includes
executing improvement processing for implementing improvement for satisfying the application condition when it is determined that the data consistency maintenance processing implemented by the program corresponding to the selected data cannot be applied since the application condition is not satisfied, by the at least one computer, and
determining whether the data consistency maintenance processing implemented by the program corresponding to the selected data can be executed after the improvement processing is executed, by the at least one computer.

10. The data consistency maintenance method according to claim 8, further comprising:
providing an interface for setting the program, the application condition, and the priority order, by the at least one computer.

11. The data consistency maintenance method according to claim 7, further comprising:
newly selecting a program and executing data consistency maintenance processing implemented by the newly selected program when the failure of the transaction is detected after the data consistency maintenance processing implemented by the program corresponding to the selected data is executed, by the at least one computer.

12. The data consistency maintenance method according to claim 7, further comprising:
providing an interface for setting the specification of the local transaction in the service, by the at least one computer.
